(19) United States
(12) Patent Application Publication
(10) Pub. No.: US 2015/0024267 A1
(43) Pub. Date: Jan. 22, 2015

(54) ELECTROLYTE HAVING IMPROVED HIGH-RATE CHARGE AND DISCHARGE PROPERTY, AND CAPACITOR COMPRISING SAME

(71) Applicant: University of Seoul Industry Cooperation Foundation, Seoul (KR)

(72) Inventor: Cheol Soo JUNG, Seoul (KR)

(21) Appl. No.: 14/501,927

(22) Filed: Sep. 30, 2014

Related U.S. Application Data
(63) Continuation-in-part of application No. PCT/KR2013/001919, filed on Mar. 11, 2013.
Application No. PCT/KR2013/001919 is a continuation-in-part of application No. PCT/KR2013/001920, filed on Mar. 11, 2013.

(30) Foreign Application Priority Data
Mar. 30, 2012 (KR) 10-2012-0032955
Mar. 30, 2012 (KR) 10-2012-0032960

(51) Int. Cl. H01G 11/60; H01G 11/06; H01M 10/0569; H01M 10/0525; H01M 10/0567

(52) U.S. Cl. CPC H01G 11/60; H01M 10/0525; H01M 10/0567; H01M 10/0569; H01G 11/06
USPC 429/200; 429/188; 429/342; 429/338; 429/337; 429/341; 429/343; 429/340; 429/339; 361/502; 252/62.2; 548/544; 549/62; 570/127; 549/504; 585/24; 585/23

(57) ABSTRACT

The present invention relates to an electrolyte having improved high-rate charge and discharge property, and a capacitor comprising the same, and more particularly to an electrolyte having improved high-rate charge and discharge property comprising an aromatic compound, which comprises at least one compound of the following Chemical Formula 1 to Chemical Formula 11 that can induce resonance effect of electron movement, and which is a substituted organic compound in which a functional group is present at a location that can structurally prevent local polarization effect, and the boiling point of which is 80° C. or higher, wherein R in the Chemical Formula 1 to Chemical Formula 11 is at least one functional group selected from the alkyl group consisting of methyl, ethyl, propyl and butyl, and a capacitor comprising the same.

Further, the present invention relates to an electrolyte for a lithium secondary battery, and a lithium secondary battery using the same, and more particularly to an electrolyte for a lithium secondary battery, which is the electrolyte having improved high-rate charge and discharge property comprising a linear acrylate compound, wherein the linear acrylate compound is a linear acrylate compound composed of any one linear structure of ether, ketone, ester and amide, and a lithium secondary battery using the same.

### CROSS REFERENCE TO RELATED APPLICATIONS

This Application is a continuation-in-part of PCT/KR2013/001919 filed Mar. 11, 2013 and PCT/KR2013/001920 filed Mar. 11, 2013, which claimed the priority of Korean Patent Application No. 10-2012-0032955 filed Mar. 30, 2012, and Korean Patent Application No. 10-2012-0032960 filed Mar. 30, 2012, respectively, the contents of each of which are incorporated herein by reference in their entirety.

### FIELD OF INVENTION

The present invention relates to an electrolyte for a capacitor having improved high-rate charge and discharge property, and a capacitor comprising the same. More particularly, the present invention relates to an electrolyte for a capacitor, which can improve high-rate charge and discharge property of the capacitor by preventing unnecessary overvoltage when charging or discharging an electrochemical capacitor such as a super-capacitor and a lithium ion capacitor, and a capacitor comprising the same.

Further, the present invention relates to an electrolyte for a lithium secondary battery, and a lithium secondary battery using the same. More particularly, the present invention relates to an electrolyte for a lithium secondary battery, which can prevent that the electrolyte moving while the secondary battery is charged and discharged from deintercalating an active material from a collector, and a lithium secondary battery using the same.

### BACKGROUND OF INVENTION

Generally, an electrochemical energy storage device is a core part of a finished product essentially used to all portable information-telecommunication devices and electronic devices. Further, the electrochemical energy storage device may be definitely used as a high quality energy source in the renewable energy field, which can be applied to future electric cars, portable electronic devices and the like.

Among electrochemical energy storage devices, an electrochemical capacitor may be classified into an electrical double layer capacitor using electrical double layer principle and a hybrid super-capacitor using electrochemical oxidation-reduction reaction.

Herein, the electrical double layer capacitor is broadly used in fields, which need high output energy property, but the electrical double layer capacitor has a defect that it is used for small capacity. Comparably, the hybrid super-capacitor is a new alternative, which can improve the capacity property of the electrical double layer capacitor, and therefore, being studied a lot. In particular, among the hybrid super-capacitor, a lithium ion capacitor can have larger storage capacity about 3 to 4 times than the electrical double layer capacitor.

Electrolytes used in a high capacity capacitor are classified into an aqueous electrolyte, a non-aqueous electrolyte and a solid electrolyte. From among these, the aqueous electrolyte having high conductivity can reduce internal resistance of a basic cell, but it has low energy density due to its low using voltage.

On the other hand, in general, the non-aqueous electrolyte has higher viscosity and lower conductivity about 1/10 to 1/100 times than the aqueous electrolyte. Accordingly, when using the non-aqueous electrolyte, there is a problem that the internal resistance is increased thereby output property becomes worse than the aqueous electrolyte. However, the non-aqueous electrolyte has advantages that it can highly increase energy density of the capacitor, which is proportional to square of using voltage, due to its high applicable potential difference, it can have broad available temperature range, and it is possible to have high breakdown voltage and to become smaller. Accordingly, studies for this are actively proceeding recently.

In the case of the lithium ion capacitor, the cathode (activated carbon) is oxidized during charging due to characteristics of the capacitor electrode, and at this time, anions in the electrolyte are adsorbed to the cathode thereby maintaining stable voltage. On the other hand, during charging, lithium ions are inserted into the anode (graphite) like in the anode of a lithium secondary battery thereby working as a stable anode. At this time, an electrolyte salt dissolved in the electrolyte plays a role in stably maintaining charging voltage of the lithium ion capacitor without generating overvoltage.

At this time, when using electrolyte salt whose anion has too low electron density in the lithium ion capacitor, overvoltage is applied because it can't properly hold the charging capacity during high-rate charging. On the other hand, the higher electron density the anion has, the stronger it is adsorbed to the oxidation electrode of the lithium ion capacitor during charging, and therefore it is very likely to make overvoltage during high-rate discharging.

Accordingly, there is a need to develop a capacitor, which can embody high capacity at high-rate by inhibiting strong adsorption of the anion having high electron density to the electrode.

### SUMMARY OF INVENTION

According to one aspect, the present invention is objected to provide an electrolyte for a capacitor, which can improve high-rate charge and discharge property of the capacitor by preventing unnecessary overvoltage when charging or discharging an electrochemical capacitor such as a super-capacitor and a lithium ion capacitor, and a capacitor comprising the same.

The electrolyte having improved high-rate charge and discharge property according to one aspect of the present invention comprises an aromatic compound, which comprises at least one compound of the following Chemical Formula 1 to Chemical Formula 11 that can induce resonance effect of electron movement, and which is a substituted organic compound in which a functional group is present at a location that can structurally prevent local polarization effect, and the boiling point of which is 80° C. or higher, wherein R in the Chemical Formula 1 to Chemical Formula 11 is at least one functional group selected from the alkyl group consisting of methyl, ethyl, propyl and butyl.

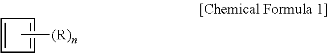

wherein R is located at position-1,3, and n is 2.

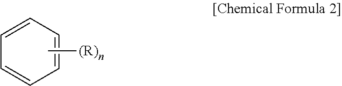

wherein R is located at position-1,4 or position-1,3,5, and n is 2 or 3.

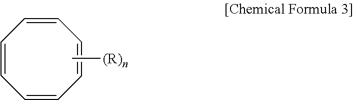

wherein R is located at position-1,5 or position-1,3,5,7, and n is 2 or 4.

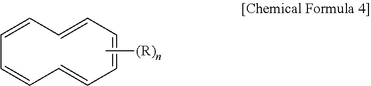

wherein R is located at any one position selected from position-1,6, position-1,3,5,7, position-1,2,7,8, position-1,3,5,7,9, position-1,2,3,6,7,8 and position-1,2,3,4,6,7,8,9, and n is 2,4,5,6 or 8.

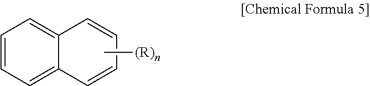

wherein R is located at any one position selected from position-1,6, position-1,3,5,7, position-1,2,7,8, position-1,3,5,7,9, position-1,2,3,6,7,8 and position-1,2,3,4,6,7,8,9, and n is 2, 4, 5, 6 or 8.

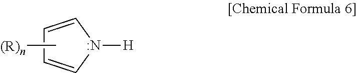

wherein R is located at any one position selected from position-2,4, position-3,5, position-3,4 and position-2,5, and n is 2.

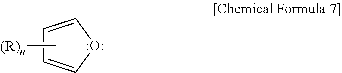

wherein R is located at any one position selected from position-2,4, position-3,5, position-3,4 and position-2,5, and n is 2.

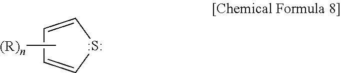

wherein R is located at any one position selected from position-2,4, position-3,5, position-3,4 and position-2,5, and n is 2.

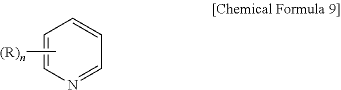

wherein R is located at position-2,4,6, and n is 3.

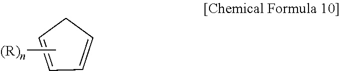

wherein R is located at position-2,5, and n is 2.

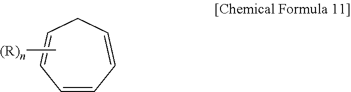

wherein R is located at position-2,4,6 or position-2,4,5,7, and n is 3 or 4.

According to the electrolyte having improved high-rate charge and discharge property of the present invention, R in the Chemical Formula 1 to Chemical Formula 11 may be any one selected from the alkoxy group consisting of methoxy, ethoxy, propanoxy and butoxy.

According to the electrolyte having improved high-rate charge and discharge property of the present invention, R in the Chemical Formula 1 to Chemical Formula 11 may be any one selected from the group consisting of fluoro, chloro and bromo.

According to the electrolyte having improved high-rate charge and discharge property of the present invention, the alkyl group in the Chemical Formula 1 to Chemical Formula 11 may contain any one selected from the group consisting of acetyl group, aldehyde group, amine group, ester group and ether group.

According to the electrolyte having improved high-rate charge and discharge property of the present invention, hydrogen (H) linked to carbon (C), which is structurally connected with the alkyl group, may be substituted with any one of fluoro, chloro and bromo.

According to the electrolyte having improved high-rate charge and discharge property of the present invention, the aromatic compound may be used in an amount of 1 to 10 parts by weight, based on 100 parts by weight of the electrolyte.

According to the electrolyte having improved high-rate charge and discharge property of the present invention, the electrolyte may comprise the aromatic compound, an electrolyte salt and a non-aqueous organic solvent. The electrolyte salt may be a mixture of at least one selected from the group consisting of LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CxF₂x₊₁SO₂)(CyF₂y₋₁SO₂) (wherein, x and y are a natural number), LiCl and LiI. The non-aqueous organic solvent may be a mixture of at least one selected from the group consisting of ethylene carbonate (EC), propylene carbonate (PC), dimethyl carbonate (DMC), diethyl carbonate (DEC), ethyl methyl carbonate (EMC), 1,2-dimethoxyethene (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO) and acetonitrile (AN).

The capacitor according to one aspect of the present invention comprises the electrolyte described above.

When manufacturing a capacitor using the electrolyte according to one aspect of the present invention, there is an effect of inhibiting strong adsorption of the anion to the electrode even if an anion having large electro density is used as the electrolyte salt. Further, the capacitor according to one aspect of the present invention has an effect of improving high-rate charge and discharge property of the capacitor by preventing unnecessary overvoltage when high-rate charging or discharging thereof.

In another aspect, the present invention is objected to provide a technology, which can inhibit deintercalation of an active material from an electrode plate. Further, the present invention is objected to provide a lithium secondary battery whose life time can be extended by inhibiting deintercalation of an active material.

The electrolyte for a lithium secondary battery according to another aspect of the present invention comprises a linear acrylate compound, wherein the linear acrylate compound is a linear acrylate compound composed of any one linear structure of ether, ketone, ester and amide.

According to the electrolyte for a lithium secondary battery of the present invention, the linear acrylate compound may be a linear acrylate compound composed of any one linear structure of ether, ketone, ester and amide.

According to the electrolyte for a lithium secondary battery of the present invention, molecular weight (Mn) of the linear acrylate compound is 1,000 to 5,000.

According to the electrolyte for a lithium secondary battery of the present invention, the electrolyte may comprise a non-aqueous organic solvent, a lithium salt and the linear acrylate compound, wherein the linear acrylate compound may be used in an amount of 0.1 to 20 wt %, based on total weight of the electrolyte. The non-aqueous organic solvent may be a mixture of at least one selected from the group consisting of ethylene carbonate (EC), propylene carbonate (PC), dimethyl carbonate (DMC), diethyl carbonate (DEC), ethyl methyl carbonate (EMC), 1,2-dimethoxyethene (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO) and acetonitrile (AN). The lithium salt may be a mixture of at least one selected from the group consisting of LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CxF₂ₓ₊₁SO₂)(CyF_{2y+1}SO₂) (wherein, x and y are a natural number), LiCl and LiI.

The lithium secondary battery according to another aspect of the present invention may be composed of the electrolyte, the anode, the cathode and a separator.

The electrolyte for a lithium secondary battery according to another aspect of the present invention, and a lithium secondary battery using the same have an effect of inhibiting drastic micro-leaning problem of the electrolyte near the collector even under a harsh charging and discharging condition. Further, the electrolyte for a lithium secondary battery according to another aspect of the present invention, and a lithium secondary battery using the same have an effect of inhibiting deintercalation of an active material from an electrode plate. Further, the electrolyte for a lithium secondary battery according to another aspect of the present invention, and a lithium secondary battery using the same have an effect of extending the life time of the battery by inhibiting deintercalation of an active material from an electrode plate.

### BRIEF DESCRIPTION OF DRAWINGS

The above and other objects and features of the present invention will become apparent from the following description of the invention taken in conjunction with the following accompanying drawings, which respectively show:

FIG. 1: pictures showing the conditions of the cathodes and separators of Examples 1 to 8, and Comparative Example 1 in the second embodiment of the present invention.

### DETAILED DESCRIPTION OF INVENTION

Hereinafter, preferred embodiments of the present invention will be described in detail with reference to the attached drawings. Throughout the accompanying drawings, the same reference numerals are used to designate the same or similar components, and redundant descriptions thereof are omitted. In the description of the present invention, when it is determined that the detailed description of the related art would obscure the gist of the present invention, the description thereof will be omitted.

The terms “approximately” and/or “substantially,” as used to designate degree, are used as the meanings of the numerals or approximations of the numerals when the manufacturing techniques and allowable errors of materials that are inherent to the corresponding meanings are presented, and are used to prevent an unconscientious infringer from unfairly using disclosed contents in which accurate or absolute numerals are given to assist understanding of the present invention.

### Electrolyte having Improved High-Rate Charge and Discharge Property according to First Embodiment of the Present Invention

The present inventors developed an organic solvent having relatively low polarity, which can prevent capacity reduction under the electrolyte condition using an anion having high electron density, and then found that a capacitor having high capacity can be embodied at high rate when adding the organic solvent to an electrolyte of an electrochemical capacitor such as a lithium ion capacitor, and invented the present invention therefrom.

In the present invention, R in the Chemical Formula 1 to Chemical Formula 11 may be at least one functional group selected from the alkyl group consisting of methyl, ethyl, propyl and butyl.

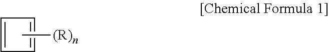

wherein R is located at position-1,3, and n is 2.

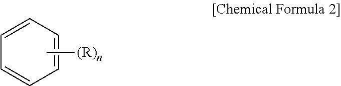

wherein R is located at position-1,4 or position-1,3,5, and n is 2 or 3.

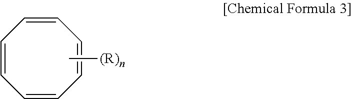

wherein R is located at position-1,5 or position-1,3,5,7, and n is 2 or 4.

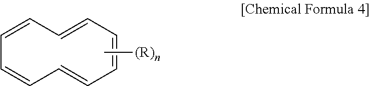

wherein R is located at any one position selected from position-1,6, position-1,3,5,7, position-1,2,7,8, position-1,3,5,7,9, position-1,2,3,6,7,8 and position-1,2,3,4,6,7,8,9, and n is 2, 4, 5, 6 or 8.

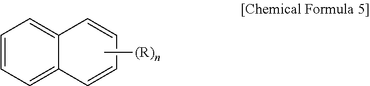

wherein R is located at any one position selected from position-1,6, position-1,3,5,7, position-1,2,7,8, position-1,3,5,7,9, position-1,2,3,6,7,8 and position-1,2,3,4,6,7,8,9, and n is 2, 4, 5, 6 or 8.

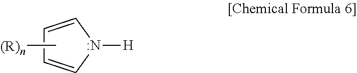

wherein R is located at any one position selected from position-2,4, position-3,5, position-3,4 and position-2,5, and n is 2.

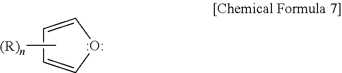

wherein R is located at any one position selected from position-2,4, position-3,5, position-3,4 and position-2,5, and n is 2.

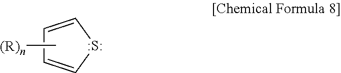

wherein R is located at any one position selected from position-2,4, position-3,5, position-3,4 and position-2,5, and n is 2.

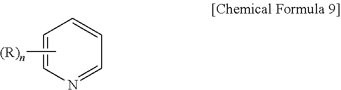

wherein R is located at position-2,4,6, and n is 3.

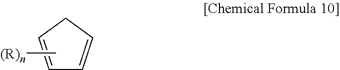

wherein R is located at position-2,5, and n is 2.

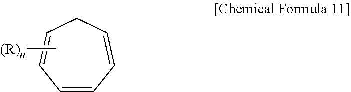

wherein R is located at position-2,4,6 or position-2,4,5,7, and n is 3 or 4.

The compounds of the Chemical Formula 1 to Chemical Formula 11 may be substituted organic compounds in which a functional group is present at a location that can structurally prevent local polarization effect, and the boiling point of which is 80° C. or higher, and a compound comprising the compounds of the Chemical Formula 1 to Chemical Formula 11 may induce resonance effect of electron movement.

The aromatic compound, in which functional groups such as identical electron donating group and electron withdrawing group is present at a location that can structurally prevent local polarization effect, is locally polarized, but the polarization characteristic is disappeared at overall compound. Thus, strong adsorption of an anion or cation at the charged electrode interface can be inhibited, thereby the electrolyte condition with excellent high-rate charge and discharge property can be made.

Further, using an organic compound having the boiling point of lower than 80° C. is not preferred because the high temperature characteristic of a capacitor may be deteriorated.

In the Chemical Formula 1 to Chemical Formula 11, R may be at least one functional group selected from the alkyl group consisting of methyl, ethyl, propyl and butyl.

Further, selectively, R in the Chemical Formula 1 to Chemical Formula 11 may be any one functional group selected from the alkyl group consisting of methoxy, ethoxy, propanoxy and butoxy.

Further, selectively, R in the Chemical Formula 1 to Chemical Formula 11 may be any one functional group selected from the group consisting of fluoro, chloro and bromo.

Further, selectively, R in the Chemical Formula 1 to Chemical Formula 11 may be a functional group wherein any one of acetyl group, aldehyde group, amine group, ester group and ether group is contained in the alkyl group.

Further, selectively, R in the Chemical Formula 1 to Chemical Formula 11 may be at least one functional group selected from the alkyl group consisting of methyl, ethyl, propyl and butyl, and hydrogen (H) linked to carbon (C), which is structurally connected with the alkyl group, may be substituted with any one of fluoro, chloro and bromo.

The electrolyte comprising the aromatic compound composed of any one compound of the Chemical Formula 1 to Chemical Formula 11 can embody a capacitor having high capacity at high rate by inhibiting strong adsorption of an anion having high electron density to the electrode.

The aromatic compound may be used in an amount of 1 to 10 parts by weight, based on 100 parts by weight of the electrolyte, preferably.

The high-rate property of a capacitor may be improved within the said range by preventing unnecessary overvoltage when charging and discharging the capacitor electrode. If the compound is used in the amount of less than 1 part by weight, the formation of overvoltage, which is formed by strong adsorption of the anion having high electron density to the electrode, can't be prevented. If the compound is used in the amount of over 10 parts by weight, it is difficult to expect a useful effect because it may cause capacity reduction against an anion having low electron density.

The electrolyte according to the present invention may be used to an electrochemical capacitor such as a super-capacitor and a lithium ion capacitor, and when manufacturing the capacitor, the electrolyte may be composed of at least one compound of the Chemical Formula 1 to Chemical Formula 11, an electrolyte salt and a non-aqueous organic solvent.

Further, as the electrolyte salt, which can be used for manufacturing the lithium ion capacitor, a mixture of at least one selected from the group consisting of LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CxF₂ₓ₊₁SO₂)(CyF_{2y+1}SO₂) (wherein, x and y are natural number), LiCl and LiI may be used as an electrolyte for a lithium ion capacitor.

Further, as the non-aqueous organic solvent, a mixture of at least one selected from the group consisting of ethylene carbonate (EC), propylene carbonate (PC), dimethyl carbonate (DMC), diethyl carbonate (DEC), ethyl methyl carbonate (EMC), 1,2-dimethoxyethene (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO) and acetonitrile (AN) may be used as an electrolyte.

When manufacturing a capacitor using the said electrolyte, there is an effect of inhibiting strong adsorption of the anion to the electrode even though using an anion having high electron density as the electrolyte salt. Accordingly, a capacitor having high capacity can be embodied because overvoltage is not applied even during high-rate charging and discharging.

On the other hand, the present invention provides a capacitor comprising the cathode, the anode, a separator and the said electrolyte.

An electrode cladding metal of the cathode is composed of a positive active material, a conducting material and a binder, and an electrode cladding metal of the anode is composed of a negative active material, a conducting material and a binder.

The positive active material may be any carbon material having double layer capacity, and for example, it may be at least one selected from the group consisting of activated carbon, natural fiber, amorphous carbon, fullerene, nanotube and graphene, but not limited thereto. Preferably, it may be activated carbon, which has large specific surface area and is cheap.

The negative active material may be any carbon material, which can be intercalated and deintercalated with lithium ion, and for example, it may be heat-treated carbon materials such as natural graphite, artificial graphite, mixed mesocarbon, mixed carbon fiber, coke and pitch, hard carbon, soft carbon and the like.

Specifically, the conducting material may be graphite, carbon black, acetylene black, ketjen black and the like.

The binder may be polyethylene, polypropylene, polyethylene terephthalate, aromatic polyamide, cellulose, stylene-butadiene rubber and the like, but it is not particularly limited if it is a material stable to the electrolyte.

Further, the separator located between the cathode and the anode prevents a short caused by contact between active materials of the two electrode plates, and holds and maintains electrolyte required for battery reaction. The separator may be any material, which have insulating property and can let a non-aqueous electrolyte solution penetrate. Specifically, it may be a porous material such as vinylon, polyamide, polypropylene, polyvinylchloride and polyethylene having voids or pores.

### EXAMPLES

Hereinafter, the present invention will be described in further detail with reference to examples, and the scope of the present invention cannot be limited thereby in any way.

### Example 1

An electrolyte was prepared by mixing a mixed organic solvent (ethylene carbonate (EC):diethyl carbonate (DEC)=30:70, volume ratio) and 0.5M LiBF₄ with an aromatic compound, which is a benzene compound of the Chemical Formula 2 (wherein n is 2, and fluoro is located at position-1,4). The aromatic compound was added in an amount of 1 part by weight, based on 100 parts by weight of the electrolyte. A capacitor was manufactured according to a general method known in the art. Specifically, activated carbon and lithium metal were cut into a proper size, and then a separator made from polyethylene porous film was inserted therebetween to manufacture an electrode assembly. The electrode assembly was inserted into a pouch, the pouch was fused except its electrolyte solution inlet, and the prepared electrolyte was injected into the inlet to complete a capacitor.

### Examples 2 and 3

The procedure of Example 1 was repeated except for adding the aromatic compound in an amount of 5 parts by weight (Example 2) and 10 parts by weight (Example 3), based on 100 parts by weight of the electrolyte.

### Example 4

The procedure of Example 1 was repeated except for using an aromatic compound, which is a benzene compound of the Chemical Formula 2 (wherein n is 2, and ethyl group is located at position-1,4), in an amount of 1 part by weight, based on 100 parts by weight of the electrolyte.

### Examples 5 and 6

The procedure of Example 4 was repeated except for adding the aromatic compound in an amount of 5 parts by weight (Example 5) and 10 parts by weight (Example 6), based on 100 parts by weight of the electrolyte.

### Example 7

The procedure of Example 1 was repeated except for using an aromatic compound, which is a pyrrole compound of the Chemical Formula 6 (wherein n is 2, and methoxy group is located at position-2,4) in an amount of 1 part by weight, based on 100 parts by weight of the electrolyte.

### Examples 8 and 9

The procedure of Example 7 was repeated except for adding the aromatic compound in an amount of 5 parts by weight (Example 8) and 10 parts by weight (Example 9), based on 100 parts by weight of the electrolyte.

### Example 10

The procedure of Example 1 was repeated except for using an aromatic compound, which is a thiophene compound of the Chemical Formula 8 (wherein n is 2, and methoxy group is located at position-2,4) in an amount of 1 part by weight, based on 100 parts by weight of the electrolyte.

### Examples 11 and 12

The procedure of Example 10 was repeated except for using adding the aromatic compound in an amount of 5 parts by weight (Example 11) and 10 parts by weight (Example 12), based on 100 parts by weight of the electrolyte.

### Example 13

The procedure of Example 1 was repeated except for using an aromatic compound, which is a furan compound of the Chemical Formula 7 (wherein n is 2, and fluoro is located at position-2,4) in an amount of 1 part by weight, based on 100 parts by weight of the electrolyte.

### Examples 14 and 15

The procedure of Example 13 was repeated except for using adding the aromatic compound in an amount of 5 parts by weight (Example 14) and 10 parts by weight (Example 15), based on 100 parts by weight of the electrolyte.

### Example 16

The procedure of Example 1 was repeated except for using an aromatic compound, which is a cyclopentadiene compound of the Chemical Formula 10 (wherein n is 2, and ethyl group is located at position-2,5) in an amount of 1 part by weight, based on 100 parts by weight of the electrolyte.

### Examples 17 and 18

The procedure of Example 16 was repeated except for adding the aromatic compound in an amount of 5 parts by weight (Example 17) and 10 parts by weight (Example 18), based on 100 parts by weight of the electrolyte.

### Comparative Example 1

The procedure of Example 1 was repeated except for only mixing a mixed organic solvent (ethylene carbonate (EC):diethyl carbonate (DEC)=30:70, volume ratio) and 0.5M LiBF₄ to prepare an electrolyte.

Discharge capacity was measured after charging the capacitors manufactured in Examples and Comparative Example at 0.2 C, 1 C, 2 C, 5 C and 10 C. The results are shown in the following Table 1.

TABLE 1

| | | Amount | | | | | |
|---|---|---|---|---|---|---|---|
| | | (Part by | Discharge Capacity (mAh/g) | | | | |
| | Compound | weight) | 0.2 C | 1 C | 2 C | 5 C | 10 C |
| Example 1 | 1.4-fluoro | 1 | 76 | 74 | 65 | 58 | 47 |
| Example 2 | benzene | 5 | 74 | 70 | 62 | 56 | 45 |
| Example 3 | | 10 | 72 | 68 | 60 | 54 | 49 |
| Example 4 | 1,4-ethyl | 1 | 77 | 74 | 66 | 58 | 46 |
| Example 5 | benzene | 5 | 73 | 69 | 60 | 54 | 44 |
| Example 6 | | 10 | 73 | 68 | 58 | 49 | 43 |
| Example 7 | 2,4-methoxy | 1 | 74 | 64 | 56 | 46 | 42 |
| Example 8 | pyrrole | 5 | 68 | 60 | 52 | 44 | 38 |
| Example 9 | | 10 | 67 | 60 | 53 | 45 | 39 |
| Example 10 | 2,4-methoxy | 1 | 73 | 67 | 52 | 46 | 40 |
| Example 11 | thiophene | 5 | 72 | 68 | 57 | 48 | 41 |
| Example 12 | | 10 | 70 | 66 | 56 | 45 | 39 |
| Example 13 | 2,4-fluoro | 1 | 72 | 68 | 60 | 57 | 46 |
| Example 14 | furan | 5 | 70 | 65 | 58 | 50 | 42 |
| Example 15 | | 10 | 69 | 62 | 54 | 46 | 40 |
| Example 16 | 2,5-ethyl | 1 | 76 | 68 | 58 | 49 | 41 |
| Example 17 | cyclo | 5 | 74 | 67 | 56 | 48 | 39 |
| Example 18 | pentadiene | 10 | 73 | 64 | 55 | 48 | 39 |
| Comparative | — | — | 75 | 65 | 52 | 37 | 23 |
| Example | | | | | | | |

As a result, it could be found that discharge capacity of the capacitors, which were manufactured by using the electrolytes comprising the compounds according to the present invention, were more excellent than Comparative Example 1. In particular, it could be found that when charging and discharging at high rate, discharge capacity of Comparative Example 1 was significantly reduced, but discharge capacity of Example 1 to Example 15 was little reduced.

Accordingly, it could be found that the present invention has an effect of embodying a capacitor having high capacity because overvoltage is not applied even though charging and discharging high capacity.

### Electrolyte for Lithium Secondary Battery according to Second Embodiment of the Present Invention

The present invention relates to an electrolyte, which can inhibit deintercalation of an active material from a collector, and is characterized that a linear acrylate compound is contained in the electrolyte.

In the case of a multi-functional acrylate compound, it is difficult to accomplish the object of the present invention, which is desired to be embodied, because the compound is difficult to be impregnated into micropores of the active material due to its molecular backbone.

The linear acrylate compound may be monoacrylate or diacrylate in which ether, ketone, ester and amide are formed in a linear structure, preferably.

Structural formulas of this linear acrylate are as follows.

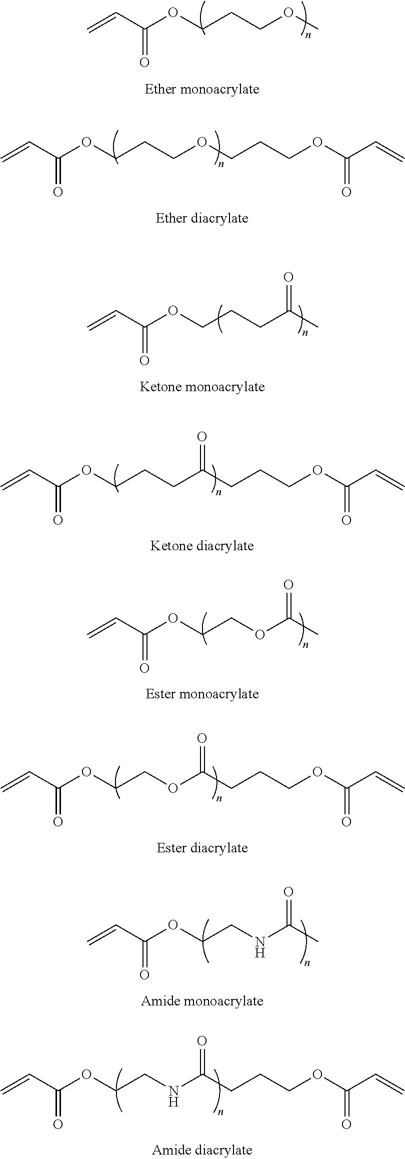

Molecular size of the linear acrylate contained in the electrolyte according to the present invention should be smaller than micro-gap between the active materials coated on the electrode plate. The size of the micro-gap is very relevant to average particle size of the active material making up the electrode plate and density of the electrode mixture.

The compound formed to the linear acrylate structure has excellent affinity with a positive active material, and is formed to a proper sized-molecular structure thereby allowed to enter the micro-gap between the active materials. As a result, it can inhibit drastic micro-leaning problem of the electrolyte near a collector. Accordingly, it can inhibit deintercalation of the active material from the electrode plate.

More specifically, when its molecular weight (Mn) is 5,000 or less, it enters the micro-gap between the active materials thereby forming a gel-type polymer.

Accordingly, the molecular weight (Mn) may be 5,000 or less, preferably, and 1,000 to 5,000, more preferably.

The positive active material may be any carbon material having double layer capacity, and for example, it may be at least one selected from the group consisting of activated carbon, natural fiber, amorphous carbon, fullerene, nanotube and graphene.

The acrylate structure, which has excellent affinity with a positive active material and is formed to a proper sized-molecular structure, can be well impregnated to a collector layer inside of the electrode plate by using the micro-gap between the active materials coated on the electrode plate, thereby forming gel.

Accordingly, the electrolyte can be stuck inside of the gel-type electrode plate, thereby can inhibit drastic micro-leaning problem of the electrolyte near a collector under a harsh charging and discharging condition. Accordingly, it can inhibit deintercalation of the active material from the electrode plate.

On the other hand, the electrolyte for a lithium secondary battery according to the present invention comprises the linear acrylate compound, a non-aqueous organic solvent and a lithium salt.

The linear acrylate compound may be used in an amount of 0.1 to 20 wt %, based on the total weight of the electrolyte, preferably. Within the said range, the compound can be well impregnated to the collector layer inside of the electrode plate and form gel, and therefore, can inhibit deintercalation of the active material from the electrode plate.

The non-aqueous organic solvent may be any one or a mixture of at least one selected from the group consisting of ethylene carbonate (EC), propylene carbonate (PC), dimethyl carbonate (DMC), diethyl carbonate (DEC), ethyl methyl carbonate (EMC), 1,2-dimethoxyethene (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO) and acetonitrile (AN).

Further, the lithium salt may be any one or a mixture of at least one selected from the group consisting of LiPF₆, LiBF₄, LiTFSI, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CxF₂x₊₁SO₂)(CyF₂y₊₁SO₂) (wherein, x and y are a natural number), LiCl and LiI.

The electrolyte for a lithium secondary battery according to the present invention and the lithium secondary battery using the same has an effect of inhibiting drastic micro-leaning problem of the electrolyte near a collector even under a harsh charging and discharging condition, thereby inhibiting deintercalation of the active material from the electrode plate.

Hereinafter, the present invention will be described in further detail with reference to examples, and the scope of the present invention cannot be limited thereby in any way.

### Example 1

An electrolyte was prepared by mixing a mixed organic solvent (ethylene carbonate (EC):diethyl carbonate (DEC)=30:70, volume ratio) and 1 M LiPF₆, and then adding ether monoacrylate (Mn 1100) in an amount of 4 wt %, based on total weight of the electrolyte. And then, the cathode, the anode and a separator were installed to manufacture a lithium secondary battery. After repeating charging and discharging 50 times at 60° C. and 5 C, deintercalation from an electrode plate was observed.

### Example 2

The procedure of Example 1 was repeated except for adding the ether monoacrylate (Mn 1100) in an amount of 10 wt %, based on total weight of the electrolyte.

### Example 3

The procedure of Example 1 was repeated except for adding the ether monoacrylate (Mn 1100) in an amount of 20 wt %, based on total weight of the electrolyte.

### Example 4

The procedure of Example 1 was repeated except for adding ester monoacrylate (Mn 1400) instead of the ether monoacrylate (Mn 1100) in an amount of 4 wt %, based on total weight of the electrolyte.

### Example 5

The procedure of Example 1 was repeated except for adding ketone monoacrylate (Mn 1600) instead of the ether monoacrylate (Mn 1100) in an amount of 4 wt %, based on total weight of the electrolyte.

### Example 6

The procedure of Example 1 was repeated except for adding amide monoacrylate (Mn 1300) instead of the ether monoacrylate (Mn 1100) in an amount of 4 wt %, based on total weight of the electrolyte.

### Example 7

The procedure of Example 1 was repeated except for adding the ether monoacrylate (Mn 4200) in an amount of 4 wt %, based on total weight of the electrolyte.

### Example 8

The procedure of Example 1 was repeated except for adding ester diacrylate (Mn 2300) instead of the ether monoacrylate (Mn 1100) in an amount of 4 wt %, based on total weight of the electrolyte.

### Comparative Example 1

The procedure of Example 1 was repeated except for only mixing a mixed organic solvent (ethylene carbonate (EC):diethyl carbonate (DEC)=30:70, volume ratio) and 1 M LiPF₆ to prepare an electrolyte.

TABLE 2

| | | | | | 5 C |
|---|---|---|---|---|---|
| | | Molecular | | Electrode | Life |
| | Linear | Weight | Amount | Plate | Time |
| | Acrylate | (Mn) | (wt %) | Condition | (%) |
| Example 1 | Ether | 1100 | 4 | Not | 85 |
| | monoacrylate | | | deintercalated | |
| Example 2 | Ether | 1100 | 10 | Not | 65 |
| | monoacrylate | | | deintercalated | |
| Example 3 | Ether | 1100 | 20 | Not | 55 |
| | monoacrylate | | | deintercalated | |
| Example 4 | Ester | 1400 | 4 | Not | 79 |
| | monoacrylate | | | deintercalated | |
| Example 5 | Ketone | 1600 | 4 | Not | 82 |
| | monoacrylate | | | deintercalated | |
| Example 6 | Amide | 1300 | 4 | Not | 75 |
| | monoacrylate | | | deintercalated | |
| Example 7 | Ether | 4200 | 4 | Not | 63 |
| | monoacrylate | | | deintercalated | |
| Example 8 | Ester | 2300 | 4 | Not | 55 |
| | diacrylate | | | deintercalated | |
| Compar- | — | — | — | Deintercalated | 50 |
| ative | | | | | |
| Example 1 | | | | | |

In the above Table 2, “5 C life time” refers to a value representing residual capacity after repeating charging and discharging 50 times at 60° C. Namely, it represents percentage against the maximum charging capacity after repeating charging and discharging 50 times at 60° C. For example, it means that in the case of Example 1, charging is conducted up to 85% after conducting charging and discharging 50 times.

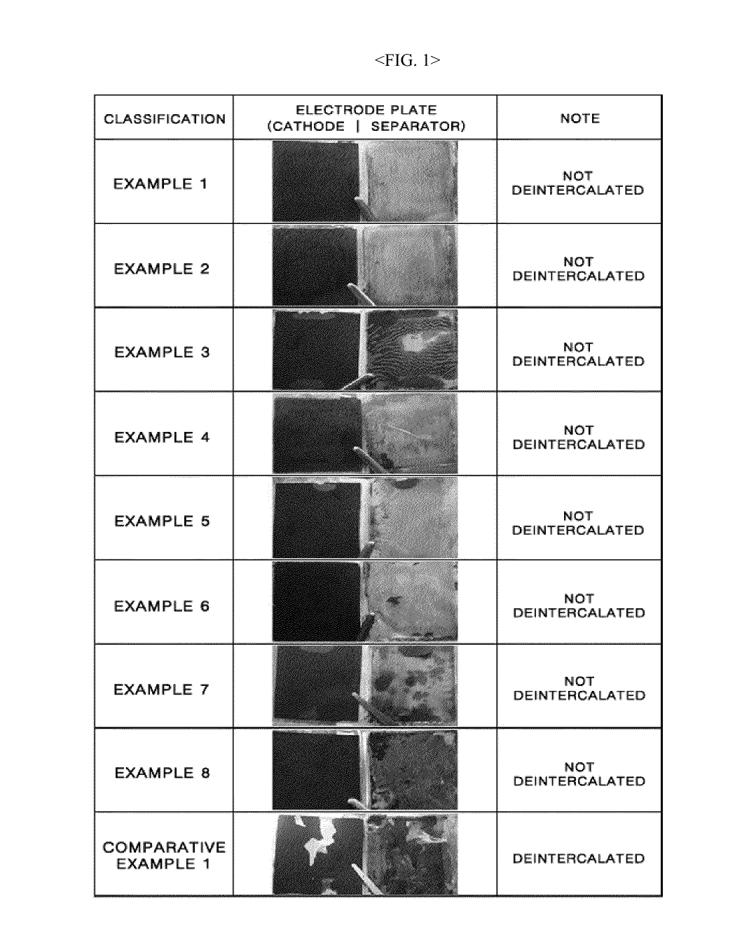

FIG. 1 is pictures showing the conditions of the cathodes and separators of Examples 1 to 8, and Comparative Example 1 in the second embodiment of the present invention.

Referring to Table 2 and pictures of FIG. 1, it could be found that in the case of the linear acrylate according to the present invention, the active material is not deintercalated from the electrode plate even under a harsh charging and discharging condition, and the life time is also increased compared to Comparative Example 1.

While the invention has been described with respect to the above specific embodiments, it should be recognized that various modifications and changes may be made and also fall within the scope of the invention as defined by the claims that follow.

What is claimed is:

1. An electrolyte having improved high-rate charge and discharge property comprising an aromatic compound, which comprises at least one compound of the following Chemical Formula 1 to Chemical Formula 11 that can induce resonance effect of electron movement, and which is a substituted organic compound in which a functional group is present at a location that can structurally prevent local polarization effect, and the boiling point of which is 80° C. or higher,
wherein R in the Chemical Formula 1 to Chemical Formula 11 is at least one functional group selected from the alkyl group consisting of methyl, ethyl, propyl and butyl. 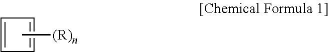
wherein R is located at position-1,3, and n is 2. 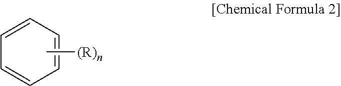
wherein R is located at position-1,4 or position-1,3,5, and n is 2 or 3. 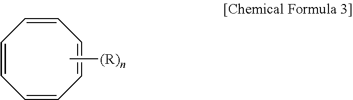
wherein R is located at position-1,5 or position-1,3,5,7, and n is 2 or 4. 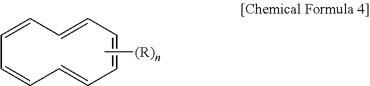
wherein R is located at any one position selected from position-1,6, position-1,3,5,7, position-1,2,7,8, position-1,3,5,7,9, position-1,2,3,6,7,8 and position-1,2,3,4,6,7,8,9, and n is 2, 4, 5, 6 or 8. 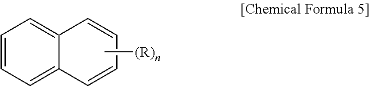
wherein R is located at any one position selected from position-1,6, position-1,3,5,7, position-1,2,7,8, position-1,3,5,7,9, position-1,2,3,6,7,8 and position-1,2,3,4,6,7,8,9, and n is 2, 4, 5, 6 or 8. 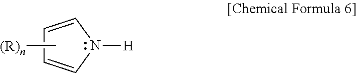
wherein R is located at any one position selected from position-2,4, position-3,5, position-3,4 and position-2,5, and n is 2. 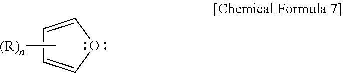
wherein R is located at any one position selected from position-2,4, position-3,5, position-3,4 and position-2,5, and n is 2. 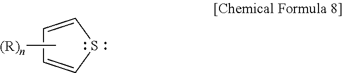
wherein R is located at any one position selected from position-2,4, position-3,5, position-3,4 and position-2,5, and n is 2. 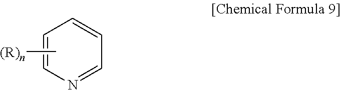
wherein R is located at position-2,4,6, and n is 3. 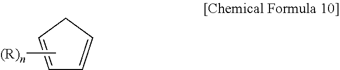
wherein R is located at position-2,5, and n is 2. 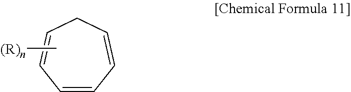
wherein R is located at position-2,4,6 or position-2,4,5,7, and n is 3 or 4.

2. The electrolyte having improved high-rate charge and discharge property according to claim 1, wherein R in the Chemical Formula 1 to Chemical Formula 11 is any one selected from the alkoxy group consisting of methoxy, ethoxy, propanoxy and butoxy.

3. The electrolyte having improved high-rate charge and discharge property according to claim 1, wherein R in the Chemical Formula 1 to Chemical Formula 11 is any one selected from the group consisting of fluoro, chloro and bromo.

4. The electrolyte having improved high-rate charge and discharge property according to claim 1, wherein the alkyl group in the Chemical Formula 1 to Chemical Formula 11 comprises any one selected from the group consisting of acetyl group, aldehyde group, amine group, ester group and ether group.

5. The electrolyte having improved high-rate charge and discharge property according to claim 1, wherein hydrogen (H) linked to carbon (C), which is structurally connected with the alkyl group, is substituted with any one of fluoro, chloro and bromo.

6. The electrolyte having improved high-rate charge and discharge property according to claim 1, wherein the aromatic compound is used in an amount of 1 to 10 parts by weight, based on 100 parts by weight of the electrolyte.

7. An electrolyte for a lithium secondary battery, which is the electrolyte having improved high-rate charge and discharge property according to claim 1 comprising a linear acrylate compound,
wherein the linear acrylate compound is a linear acrylate compound composed of any one linear structure of ether, ketone, ester and amide.

8. The electrolyte for a lithium secondary battery according to claim 7, wherein molecular weight (Mn) of the linear acrylate compound is 1,000 to 5,000.

9. The electrolyte for a lithium secondary battery according to claim 7, which comprises a non-aqueous organic solvent, a lithium salt and the linear acrylate compound,
wherein the linear acrylate compound is contained in an amount of 0.1 to 20 wt %, based on total weight of the electrolyte.

10. The electrolyte for a lithium secondary battery according to claim 9, wherein the non-aqueous organic solvent is any one or a mixture of at least one selected from the group consisting of ethylene carbonate (EC), propylene carbonate (PC), dimethyl carbonate (DMC), diethyl carbonate (DEC), ethyl methyl carbonate (EMC), 1,2-dimethoxyethene (DME), γ-butyrolactone (BL), tetrahydrofuran (THF), 1,3-dioxolane (DOL), diethyl ether (DEE), methyl formate (MF), methyl propionate (MP), sulfolane (S), dimethyl sulfoxide (DMSO) and acetonitrile (AN).

11. An electrochemical device comprising any one electrolyte of claims 1 to 10.

12. The electrochemical device according to claim 11, which is a lithium ion secondary battery or a capacitor.
